(19) United States
(12) Patent Application Publication
(10) Pub. No.: US 2013/0232053 A1
(43) Pub. Date: Sep. 5, 2013

(54) FINANCIAL INSTRUMENT DISCOVERY, TRANSPARENCY, COMMUNICATION, AND TRADING FACILITATION

(71) Applicant: DERIVATRUST TECHNOLOGIES. INC., San Jose, CA (US)

(72) Inventors: Thomas SACHSON, Menlo Park, CA (US); Hieu TRAN, San Jose, CA (US)

(73) Assignee: DerivaTrust Technologies. Inc., San Jose, CA (US)

(21) Appl. No.: 13/857,094

(22) Filed: Apr. 4, 2013

Related U.S. Application Data
(63) Continuation of application No. 13/449,310, filed on Apr. 17, 2012.
(60) Provisional application No. 61/558,028, filed on Nov. 10, 2011.
(60) Provisional application No. 61/476,350, filed on Apr. 18, 2011.

(51) Int. Cl. G06Q 40/04

(52) U.S. Cl. CPC G06Q 40/04
USPC 705/37

(57) ABSTRACT

This disclosure allows parties to virtualize prospective and existing financial instruments (including derivative and other analogous complex financial instruments) and other data set into one or more computer software applications via a user authoring software toolkit, and to upload such one or more virtualized instrument to a cloud hosting environment (or analogous online storage ecosystem) for further sharing of such virtualized instruments with interested parties over a communications network where other market participants may engage with the cloud hosting environment and search for, download, and review such virtualized instruments. Further, the Disclosure allows for downloading parties and authors to communicate directly and to do such “peer to peer” communications on an anonymous, partially anonymous, or non-anonymous basis, and have such communications be secure and/or encrypted.

### CROSS-REFERENCE

This application is a continuation of U.S. application Ser. No. 13/449,310, which claims the benefit of U.S. Provisional Applications Nos. 61/476,350, entitled “Derivative Contract Trading Facilitation Platform”, filed on Apr. 18, 2011, and, 61/558,028, entitled “Derivative Contract Trading Facilitation Platform”, filed on Nov. 10, 2011, the contents of all of which are incorporated herein by reference.

### BACKGROUND OF THE DISCLOSURE

The current size and complexity of the over the counter (OTC) financial instrument market (including the derivatives market and other analogous markets for complex and non-standardized financial instruments) mandates the need for improved financial instrument discovery, financial market participant discovery, financial instrument price transparency, market participant communications, and market clearing and settlement capabilities amongst participants. However, the traditional methods for facilitating such activities (a centralized exchange, registry, clearinghouse, etc.) are ill suited to accomplishing this task due to concerns about costs, accessibility, and security.

As such, a new Financial Instrument Discovery, Transparency, Communication, and Trading Facilitation system and method (the current “Disclosure”) is needed to accomplish to following objectives:

(1) Provide and/or facilitate greater ease of financial instrument (e.g., derivative instrument) market participants (e.g., counterparties) to find (e.g., discover) other complementary market participants with which to do business;

(2) Provide and/or facilitate greater ease of financial instrument market participants to securely communicate (e.g., with bilateral anonymity, unilateral anonymity, or no anonymity) on a “peer to peer” basis with other market participants;

(3) Provide and/or facilitate greater ease of financial instrument market participants to assess the nature (e.g., characteristics and credibility) of other market participants prior to communicating and/or otherwise engaging with such other market participants;

(4) Provide and/or facilitate greater ease of financial instrument (e.g., derivative instrument) market participants (e.g., counterparties) to find (e.g., discover) numerous new, existing, or prospective financial instruments within the broader financial markets;

(5) Provide and/or facilitate greater ease of financial instrument market participants to enter new and existing financial instrument markets;

(6) Provide and/or facilitate improved pricing transparency of financial instruments;

(7) Provide and/or facilitate improved trading liquidity relating to financial instruments;

(8) Provide and/or facilitate improved pricing of financial instruments;

(9) Provide and/or facilitate improved record keeping and storage of data relating to financial instruments (including requisite backup and disaster recovery apparatus as needed);

(10) Provide and/or facilitate improved market abilities for determining the size and characteristics of financial instrument markets by all market participants (including but limited to counterparties, regulators, academics, the media, and any other party having a direct or indirect interest in the operation of financial instruments markets); and

(11) Providing a secure, customizable, low-cost, and easy to use alternative to market participants wishing to engage in the discovery of, review of, creation of, communication pertaining to, negotiation of, and/or sale or exchange of financial instruments without being forced to use and/or pay for a more expensive, less flexible, and more formalized listing mechanisms such as those represented by traditional centralized clearinghouses, exchanges, and registries.

Moreover, the aforementioned objectives must be accomplished in a manner that is easily understood by the financial instrument markets, regulators, the media, and others concerned with the efficient operation of financial instrument markets, with minimal costs (e.g., ideally little or no costs to the participants until a transaction or value added action is effected), is secure, scalable, and inclusive to all suitable and appropriate participants.

In light of these goals and requirements, the enclosed Financial Instrument Discovery, Transparency, Communication, and Trading Facilitation platform (the current “Disclosure”) has been created and is composed of unique and novel technology elements configured so as to create an effective system and method that is a marked improvement over the current art.

By enabling these improvements the subject disclosure solves the shortcomings of the prior art by creating a new mechanism by which people can search out and make meaningful new social connections relating to the financial markets in which they operate and do so efficiently and securely via the Internet.

### SUMMARY

The subject disclosure relates generally to user-generated content sharing systems and associated methods of operation and relates to a self- publishing, social networking system that is accessible by a plurality of entities over a network such as the Internet and engages in the creation, storing, searching, access, interaction, and communication relating to user-generated financial instrument data.

Specifically, the Financial Instrument Discovery, Transparency, Communication, and Trading Facilitation platform (the “Disclosure”) allows individuals wishing to create, record, and publish data pertaining to prospective and existing financial instruments to do so in a low-cost, secure, and efficient manner, and further facilitates the discovery and review of such memorialized financial instruments by third parties and to further facilitate the communication between the creators or such memorialized financial instruments and the parties that discover such, and do so in a manner that is well-suited to a global Internet user base that desires to use social networking techniques as it engages in these types of activities.

Further, the method and apparatus pertaining to this disclosure may comprise a tangible machine readable medium storing instructions that, when executed by a computing device, cause the computing device to perform a method, which may comprise creating one or more data sets accessible by a plurality of entities over a network such as the Internet and engage in the creation, storing, searching, accessing, interacting, and communication relating to user-generated financial instrument data.

The system and method may be implemented on a computing device utilizing instructions from a tangible machine readable medium.

### BRIEF DESCRIPTION OF THE DRAWINGS

The features, aspects and advantages of the disclosed and claimed subject matter of the present application are set forth with particularity in the appended claims. A better understanding of the aspects, features, and advantages of the disclosed and claimed subject matter will be obtained by reference to the following detailed description that sets forth what are meant to be only illustrative embodiments and not limiting disclosures, in which the principles of the Disclosure are utilized, and the accompanying drawings of which:

FIG. 1 illustrates a block diagram of the initial elements of the Disclosure where a System Administrator maintains a Networked Computer System and Database that produces a Parent Software Generator (e.g., an “application development kit”, “ADK” or “toolkit”) that is electronically delivered to an application authoring party (the Parent Software Generator User) who uses the Parent Software Generator to create another software application (e.g., a Child Software Application, being an application that is native or otherwise) representing a prospective or existing financial instrument and delivers such resulting financial instrument application (the created “child” application or Child Software Application) to an Online Storage Facility resident within the cloud and maintained by the System Administrator;

FIG. 2 illustrates a block diagram of the next elements of the Disclosure where the Child Software Application (the financial instrument application) resides in the cloud-based Online Storage Facility with other similarly situated Child Software Applications, and may be searched for and downloaded by a Child Software Application Downloading Party and when downloaded to the Child Software Application Downloading Party's remote location (e.g., their PC, tablet, phone) can be stored, reviewed, and interacted with by the Child Software Application Downloading Party. Further, as shown in this FIG. 2 block diagram, the Child Software Application may be capable of being opened and engaged with by a Child Software Application Downloading Party on a stand-alone application basis or with the support and assistance of a separate software application such as Child Software Application Reader or with the support and assistance of the Parent Software Generator that may also have an ability to open, read, and support the Child Software Application Downloading Party's engagements with any one or more Child Software Applications resident on their remote location;

FIG. 3 illustrates a block diagram of the next elements of the Disclosure where the Child Software Application resides within the Child Software Application Downloading Party's remote location and such application (perhaps in conjunction with the Child Software Application Reader that enables the functionality of Child Software Application) communicates (paths illustrated) with the System Administrator's Message Server for purposes of connecting the Software Application Downloading Party with the Parent Software Generator User that created that particular Child Software Application and further facilitating further message flow between the Child Software Application Downloading Party and the Parent Software Generator User via various paths illustrated;

FIG. 4 illustrates a block diagram of the communication elements of the Disclosure where the Child Software Application communicates a message to the Parent Software Generator User (pursuant to instructions provided to it by the user of the Child Software Application) via the System Administrator's Message Server which communicates with the Parent Software Generator User (utilizing his own Parent Software Generator as a messaging device) that created that particular Child Software Application, as well as showing scenarios where the user of the Child Software Application communicates with the assistance of either a Parent Software Generator or a Child Software Application Reader, as well as the use of secure User Identification Code Databases and User Addressing Databases for protecting the identities of the Disclosure's users as they communicate anonymously or non-anonymously via the System Administrator's Message Server;

FIG. 5 illustrates a block diagram of the communication elements of the Disclosure where the Child Software Application receives a communication from a Parent Software Generator (pursuant to instructions provided to it by the Parent Software Generator User) via the System Administrator's Message Server which receives such communication from the Parent Software Generator User (utilizing his own Parent Software Generator as a messaging device) that created that particular Child Software Application, as well as showing scenarios where the user of the Child Software Application communicates with the assistance of either a Parent Software Generator or a Child Software Application Reader, as well as the use of secure User Identification Code Databases and User Addressing Databases for protecting the identities of the Disclosure's users as they communicate anonymously or non-anonymously via the System Administrator's Message Server;

FIG. 6 illustrates a block diagram of the communication elements of the Disclosure illustrating the communication paths that are encrypted as the user of the Child Software Application communicates via the System Administrator's Message Server with the Parent Software Generator User that created that particular Child Software Application, as well as the various permutations of software elements (Parent Software Generator and the Child Software Application) that can be used to facilitate such communications within the Disclosure;

FIG. 7 illustrates a block diagram of the communication elements of the Disclosure illustrating the communication paths that are encrypted as the user of the Child Software Application communicates via the System Administrator's Message Server with the Parent Software Generator User that created that particular Child Software Application, as well as the various permutations of software elements (Child Software Application Reader, Parent Software Generator, and the Child Software Application) that can be used to facilitate such communications within the Disclosure;

FIG. 8 illustrates a block diagram of two current mechanisms for the promotion of financial instrument trading within the markets, namely the ad hoc, partially automated peer-to-peer over the counter trading model and the electronically automated centrally cleared and settled exchange model; and

FIG. 9 illustrates a block diagram of the current Disclosure showing itself to be a new technology embodiment combining the (i) peer-to-peer elements of the over the counter method with (ii) the electronically automated aspects of the exchange method, where the counterparties can instead engage in peer-to-peer over the counter financial instrument interactions utilizing the Disclosure's novel electronically enabled financial instrument creation, publication, discovery and communication system.

### DETAILED DESCRIPTION

Aspects, features and advantages of the disclosed and claimed subject matter can be seen in the description herein of a user-generated financial instrument content creation, storage, search, and sharing system, also referred to as the Financial Instrument Discovery, Transparency, Communication, and Trading Facilitation Disclosure.

In the Disclosure's most basic embodiment, the System Administrator 1 creates and distributes (via a web-based online home page, portal, hosting environment, or storefront) one or more application development toolkits (each toolkit a “Parent Software Generator 3”) to one or more market participants (each one a “Parent Software Generator User 4” who wish to use the Parent Software Generator 3 to create unique Child Software Applications 5 that represent actual or prospective financial instruments owned by, created by, being sold by, being purchased by, and/or associated with the Parent Software Generator User 4 where such Child Software Applications 5 are then uploaded by the Parent Software Generator User 4 to an Online Storage Facility 6 operated by or in conjunction with the System Administrator 1 so as to be searchable and downloadable by third parties (each one a “Child Software Application Downloading Party 7”) who are interested in downloading, reviewing, and/or interacting with the Child Software Application 5.

Once downloaded by the Child Software Application Downloading Party 7, the Child Software Application 5 can be used to send messages (and at various times either encrypted or not-encrypted, and either anonymous or non-anonymous) to and from the Child Software Application Downloading Party 7 and the Parent Software Generator User 4 for the purposes of facilitating the financial market's need for improved financial instrument discovery, financial instrument participant discovery, financial instrument price transparency, financial instrument market participant communication capability, financial instrument market clearing and settlement capabilities amongst participants, financial instrument regulatory insight, and other analogous financial instrument market requirements.

Specifically, the Disclosure contemplates that each Parent Software Generator 3 provided by the System Administrator 1 is assigned by the system its own unique Parent Software Generator Identification Code 18 where that identification code is incorporated into that distinct Parent Software Generator 3. Similarly, the system assigns each user of a particular Parent Software Generator 3 (the Parent Software Generator User 4) their own unique Parent Software Generator User Identification Code 26 at the time the prospective Parent Software Generator User 4 registers with the system. These two codes, used together or independently can enable the system to track which parties and toolkits are authoring what Child Software Applications 5 (representing distinct prospective or existing financial instruments) at any given time and location.

In terms of the Child Software Applications 5 generated, the Disclosure enables a Parent Software Generator User 4 to create any number of applications (either native applications or otherwise) that are virtualized versions of various financial instruments (e.g., usually, but not limited to, complex, illiquid financial contracts, such as derivative contracts) owned by, created by, being sold by, being purchased by, and/or associated with the Parent Software Generator User 4. Once a Child Software Application 5 is created by the Parent Software Generator 3 (incorporating unique data sets into the Child Software Application 5 itself from Parent Software Generator User 4 inputting the same into Parent Software Generator 3), the Disclosure or the Parent Software Generator 3 is capable of assigning a unique Child Software Application Identity Code 17 to that particular application representing the financial instrument and uploading the newly created Child Software Application 5 into an Online Storage Facility 6 (such as a portal, hosting environment, store, or analogous web-based repository for these applications) that is operated by the System Administrator 1. Once uploaded and stored within the Online Storage Facility 6, the Child Software Application 5 is accessible by any party that has registered (each one a “Application Seeking Registrant”, who may also become a Child Software Application Downloading Party 7 if they also proceed to download a Child Software Application 5 from the Online Storage Facility 6) with the System Administrator 1 for access to the system's Online Storage Facility 6 (e.g., hosting environment). Application Seeking Registrants to the system may engage with the stored Child Software Applications 5 in several ways, including through the use of a Child Software Application Reader 8 as provided by the system to the Application Seeking Registrant (or the Child Software Application Downloading Party 7 as the case may be), or through a similar function embedded within the Parent Software Generator 3 if previously made available to the Application Seeking Registrant, or through a traditional web browser with appropriate Child Software Application 5 permission elements pre-installed and enabled. In each case, the Application Seeking Registrant will be capable of any one or more of searching the Online Storage Facility 6, downloading Child Software Applications 5 from the Online Storage Facility 6, reviewing the same directly through the Child Software Application 5 itself as it is opened, or from within the Child Software Application Reader 8 (or enabled Parent Software Generator 3 or browser as the case may be), and thereafter engaging in message delivery between itself as the Child Software Application Downloading Party 7 to a Parent Software Application User 4.

The disclosure contemplates that the system may further assign each Application Seeking Registrant a Child Software Application Downloading Party Identification Code and/or an Application Seeking Registrant Identification Code if doing so will facilitate the functioning of the Disclosure, or in the alternative the Disclosure may not assign such a code to an Application Seeking Registrant until such time as the System Administrator 1 needs to track the activities of the Application Seeking Registrant more closely to effect the more advanced features of the Disclosure (e.g., sending messages will require the creation of a Child Software Application Downloading Party Identification Code , but the mere searching for, downloading of, and review of Child Software Applications 5 may not require704160006v1 the assignment to the Application Seeking Registrant of either a Child Software Application Downloading Party Identification Code or an Application Seeking Registrant Identification Code).

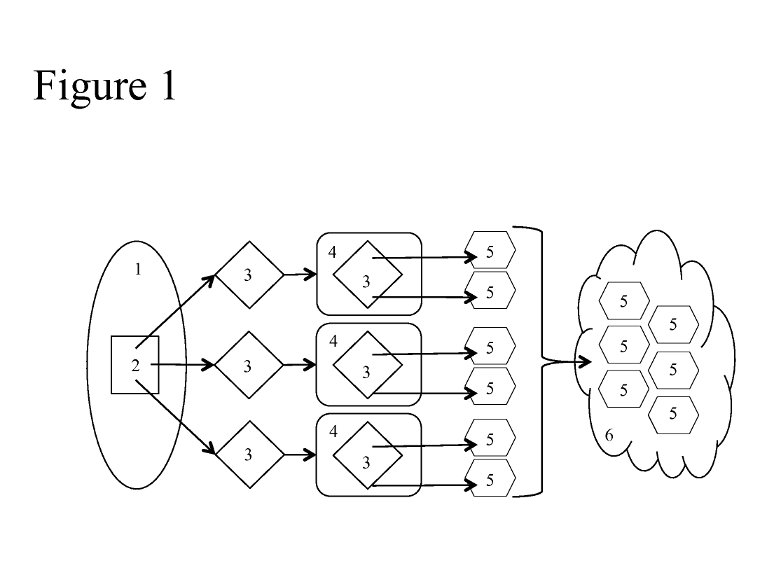

By way of example, FIG. 1 sets forth a block diagram where the System Administrator 1 manages a Networked Computer System and Database 2 that delivers a Parent Software Generator 3 to a party seeking to be a Parent Software Generator User 4 (upon request of the Parent Software Generator User 4). Thereafter, the Parent Software Generator User 4 uses Parent Software Generator 3 to create a Child Software Application 5 that is a virtualized version of a prospective or existing financial instrument associated with the Parent Software Generator User 4 (memorializing some or all of the terms of the financial instrument). Once generated, the Parent Software Generator User 4 instructs the Parent Software Generator 3 to upload the Child Software Applications 5 to an Online Storage Facility 6 administered by the System Administrator 1. This Online Storage Facility 6 (e.g., hosting environment, portal, store, web page, or analogous) then serves as a repository for numerous Child Software Applications 5 created by numerous Parent Software Generators 3 propagated throughout the markets.

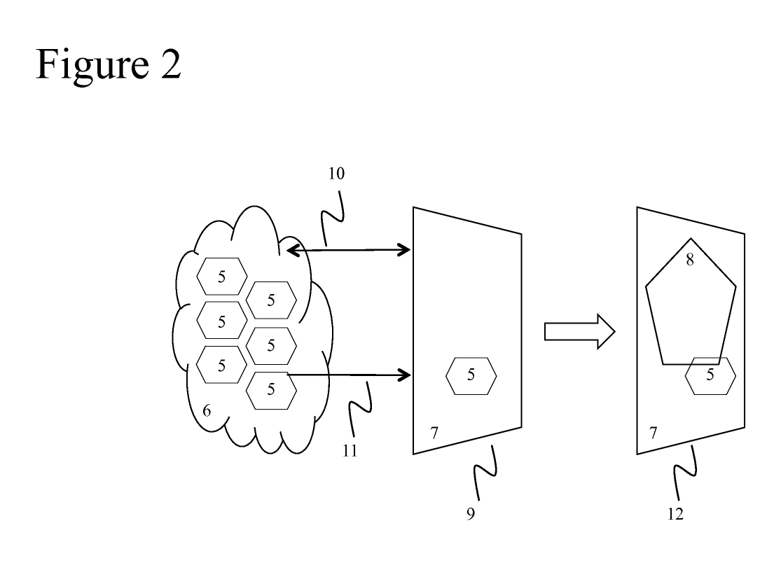

Turning to FIG. 2, with such a repository being accessible online, the Child Software Application 5 contents therein are freely searchable 10 and downloadable 11 by any Application Seeking Registrant (thereby becoming a Software Application Downloading Party 7) or any similarly permission holding party authorized by the System Administrator 1. Once downloaded to the Software Application Downloading Party's 7 local hosting environment 9, the Child Software Application 5 can be opened, read, and interacted with as a stand-alone application (e.g., Java, Android) or if need be opened, read, and interacted with via a Child Software Application Reader 8 co-located with the Child Software Application 5 within the Software Application Downloading Party's 7 local hosting environment 12 (e.g., the Software Application Downloading Party's 7 own computer system).

Upon download, the Software Application Downloading Party's 7 is free to run Child Software Applications 5 and input its own data in fields where the Parent Software Generator User 4 has specified that such inputs be permitted. Similarly, Child Software Applications 5 can be authored by the Parent Software Generator User 4 in such a way that instructions for external data feeds are embedded within Child Software Applications 5 and capable of incorporating such streams once opened by the Software Application Downloading Party 7 in the locally hosted environment 12. In the alternative, Child Software Applications 5 can be authored by the Parent Software Application User 4 in such a way that instructions for external data feeds are determined by the Software Application Downloading Party 7 subsequent to the Software Application Downloading Party 7 opening the Child Software Application 5. In either case, the data feeds may be free or paid for by the System Administrator 1, the Parent Software Generator User 4, the Software Application Downloading Party 7, another third party (e.g., an application agent or sponsor), or any combination thereof

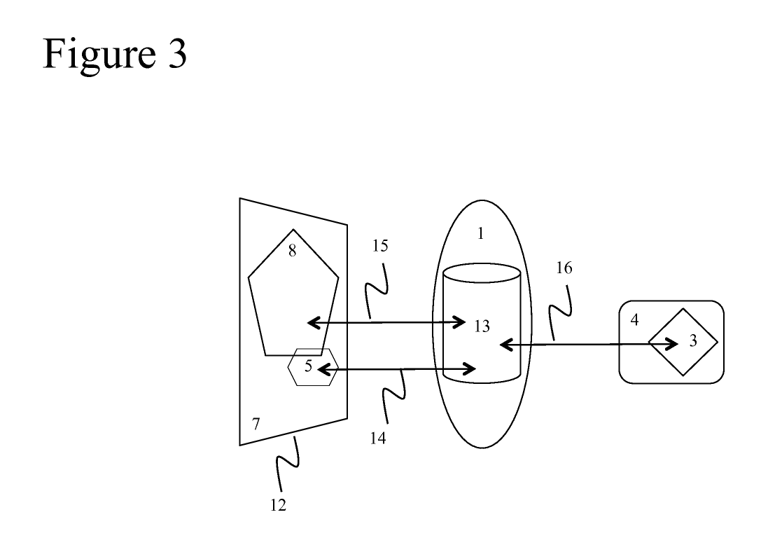

As seen in FIG. 3, once the Software Application Downloading Party 7 has reviewed and/or interacted with the Child Software Application 5, the Child Software Application 5 will allow the Software Application Downloading Party 7 to communicate directly (peer-to-peer), and if requested anonymously, with the Parent Software Generator User 4 that created the Child Software Application 5 and who is associated with the financial instrument represented by the Child Software Applications 5. Further, such communications can be encrypted by the system or not, or only encrypted at certain stages by the system, and further such communication characteristics can be determined at the instruction of (and discretion of) any one or more of the System Administrator 1, the Software Application Downloading Party 7, or the Parent Software Generator User 4. Throughout this process, the System Administrator 1 is facilitating these communications by having a system Message Server 13 route communication data flows between the various communicating parties, whether the messages be created or received by a Child Software Application 5 itself, the Child Software Application Reader 8 that supports such a Child Software Application 5, or the Parent Software Generator User 4 (represented by arrows 14, 15, and 16 respectively).

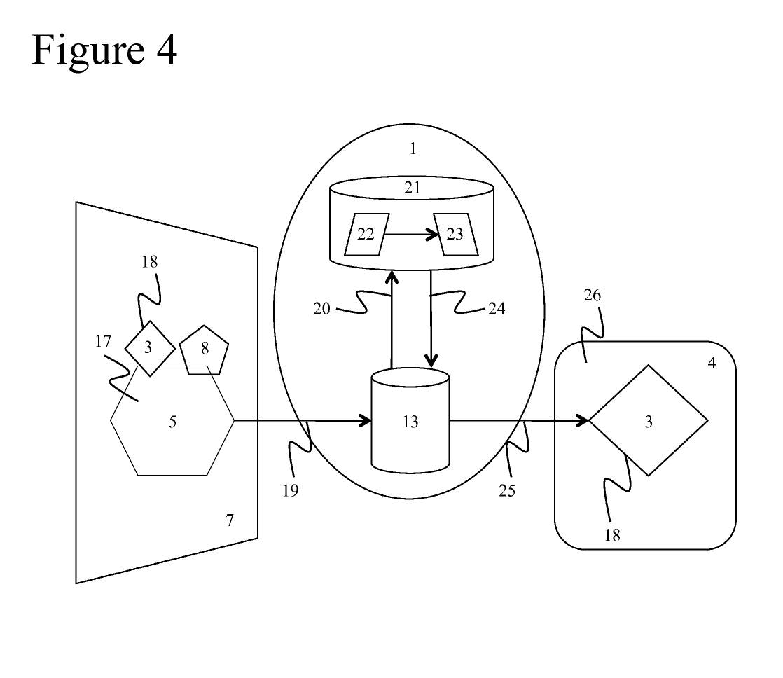

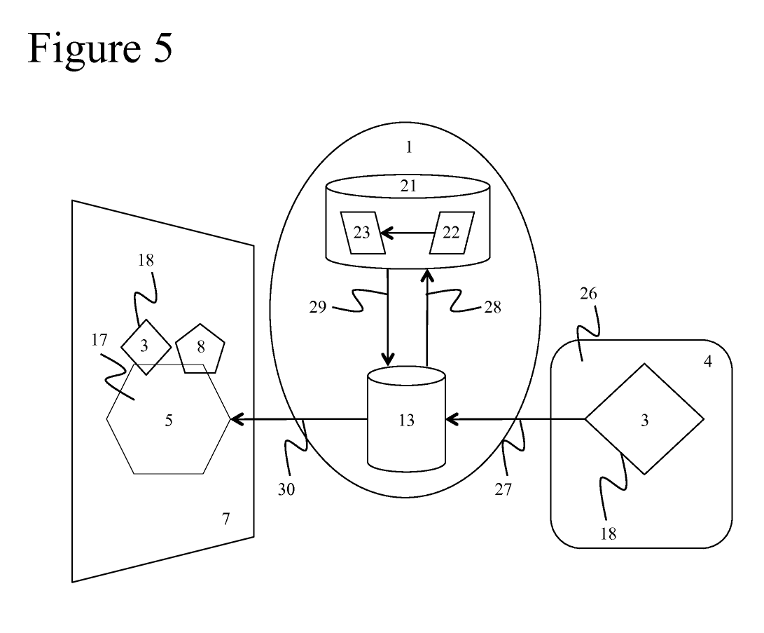

As a general rule, in the most basic embodiment of the Disclosure (see FIG. 4), communications from the Software Application Downloading Party 7 to the Parent Software Generator User 4 (and vice versa as seen in FIG. 5) are to be anonymous unless one or more of the communicating parties volunteers to disclose their identity to the other party. The process of preserving anonymity is based on having the various identification codes (Parent Software Generator Identification Code 18, Child Software Application Identification Code 17, Parent Software Generator User Identification Code 26, Application Seeking Registrant Identification Code, and/or Child Software Application Downloading Party Identification Code) being stored in a separate User Identification Code Databases 22 associated with the Message Server 13 and having the actual corresponding name and addressing information for the various participants being stored in a distinct and secure User Addressing Databases 23 also associated with the Message Server 13 (and in one embodiment both User Identification Code Databases 22 and the User Addressing Databases 23 are housed within one Computer Sub-Subsystem 21), and having the User Identification Code Databases 22 being able to coordinate communication instructions 19 received by the Message Server 13 from the Child Software Application 5 (whether or not enabled by a Parent Software Generator 3 or a Child Software Application Reader 8) and subsequently routed from the message sever 13 via path 20 to the User Identification Code Databases 22 and forwarded to the User Addressing Databases 23 which then relays via path 24 the communication data back to the Message Server 13 for further delivery via path 25 to the Parent Software Application User 4 utilizing the Parent Software Generator 3 as its peer-to-peer system messaging component. As a result, the message being delivered to the recipient is capable of being stripped of any identifying meta data by the system that would prevent the in-system communication from being anonymous from the perspective of the party sending the communication (the Software Application Downloading Party 7) and the party receiving the communication (the Parent Software Generator User 4). However, the system also allows for either party (or both parties) to identify itself (instructing the Disclosure to not strip out identification data) at anytime prior to or immediately following a communication data flow process, thereby enabling complete or unilateral non-anonymous communication flows at any time.

As seen in FIG. 5, the message flow is reversed from the flow described in FIG. 4 (the communication flow moving from the Parent Software Generator User 4 to the Software Application Downloading Party 7), yet invoking the same elements of the system described and shown on FIG. 4. In FIG. 5 the process of preserving anonymity is again based on having the various identification codes (Parent Software Generator Identification Code 18, Child Software Application Identification Code 17, Parent Software Generator User Identification Code 26, Application Seeking Registrant Identification Code, and/or Child Software Application Downloading Party Identification Code) being stored in the separate User Identification Code Databases 22 associated with the Message Server 13 and having the actual corresponding name and addressing information for the various participants being stored in a distinct User Addressing Databases 23 also associated with the Message Server 13 (and in one embodiment both User Identification Code Databases 22 and the User Addressing Databases 23 being housed within one computer Sub-Subsystem 21), and having the User Identification Code Databases 22 being able to coordinate communication instructions 27 received by the Message Server 13 from the Parent Software Generator 3 and subsequently routed from the message sever 13 via path 28 to the User Identification Code Databases 22 and forwarded to the User Addressing Databases 23 which then relays via path 29 the communication data back to the Message Server 13 for further delivery via path 30 to the Child Software Application 5 (whether or not enabled by a Parent Software Generator 3 or a Child Software Application Reader 8 being utilized as its peer-to-peer system messaging component). As a result, the message being delivered to the recipient is capable of being stripped of any identifying meta data by the system that would prevent the in-system communication from being anonymous from the perspective of the party sending the communication (the Parent Software Generator User 4) and the party receiving the communication (the Software Application Downloading Party 7). However, the system also allows for either party (or both parties) to identify itself (instructing the system to not strip out identification data) at anytime prior to or immediately following a communication data flow process, thereby enabling complete or unilateral non-anonymous communication flows at any time.

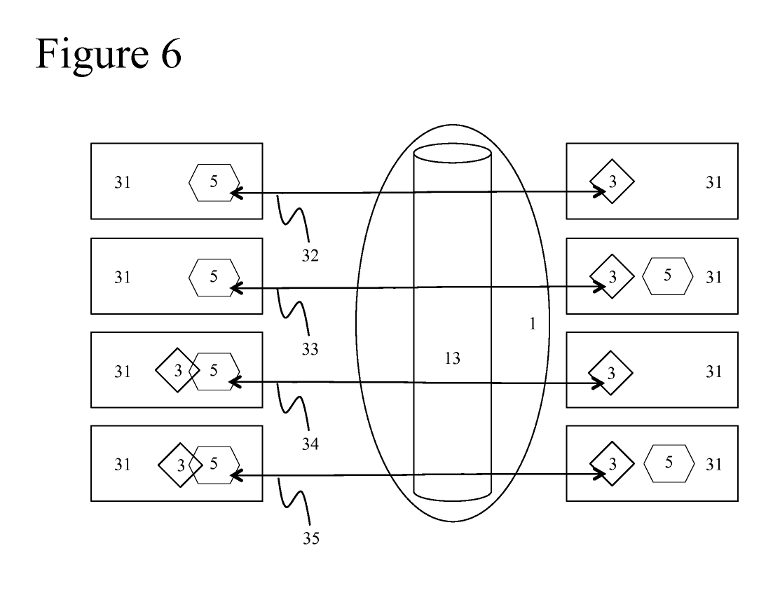

Further, the Disclosure enables various market participants to act as either only Application Seeking Registrants, Software Application Downloading Parties 7, or Parent Software Generator Users 4, or as any combination thereof (e.g., Application Seeking Registrant and Parent Software Generator User 4). However, at all times the parties engaging to use the system are actual or prospective Financial Instrument Market Participants 31 (e.g., brokers, dealers, institutions, buy-side institutions, sell-side institutions, counterparties, regulators, or analogous) and can communicate in a variety of ways using various elements of the Disclosure. Specifically, looking at FIG. 6 the block diagram shows four communication scenarios where the Financial Instrument Market Participants 31 may communicate with each other using the following combination of system elements: (a) where one Financial Instrument Market Participant 31 communicates via path 32 from a Child Software Application 5 through the Message Server 13 with another distinct Financial Instrument Market Participant 31 utilizing a Parent Software Generator 3; (b) where one Financial Instrument Market Participant 31 communicates via path 33 from a Child Software Application 5 through the Message Server 13 with another distinct Financial Instrument Market Participant 31 utilizing a Parent Software Generator 3, but where the other distinct Financial Instrument Market Participant 31 is also a Child Software Application Downloading Party 7; (c) where one Financial Instrument Market Participant 31 communicates via path 34 from a Child Software Application 5 (supported by a Parent Software Generator 3) through the Message Server 13 with another distinct Financial Instrument Market Participant 31 utilizing a Parent Software Generator 3; and (d) where one Financial Instrument Market Participant 31 communicates via path 35 from a Child Software Application 5 (supported by a Parent Software Generator 3) through the Message Server 13 with another distinct Financial Instrument Market Participant 31 utilizing a Parent Software Generator 3, but where the other distinct market participant is also a Child Software Application Downloading Party 7.

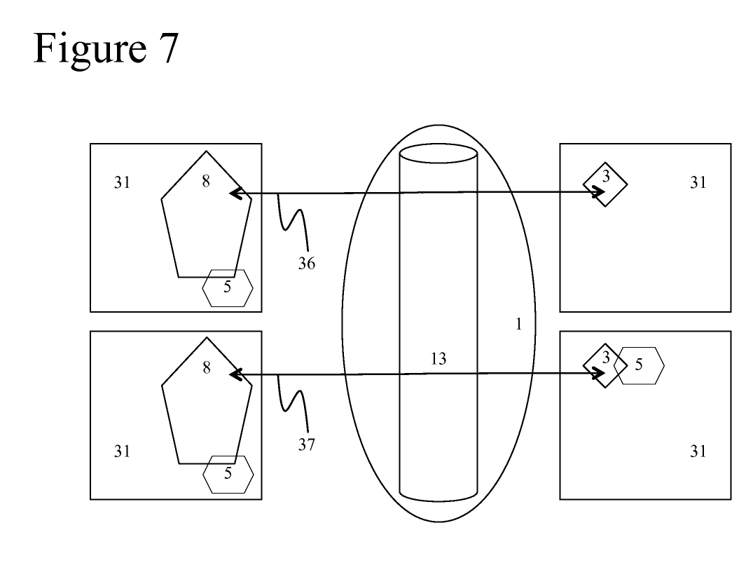

Similarly, in FIG. 7 two more options are envisioned by the system for Financial Instrument Market Participants 31 to communicate: (a) where one Financial Instrument Market Participant 31 communicates via path 36 from a Child Software Application 5 (supported by a Child Software Application Reader 8) through the Message Server 13 with another distinct Financial Instrument Market Participant 31 utilizing a Parent Software Generator 3; and (b) where one Financial Instrument Market Participant 31 communicates via path 37 from a Child Software Application 5 (supported by a Child Software Application Reader 8) through the Message Server 13 with another distinct market Financial Instrument Market Participant 31 utilizing a Parent Software Generator 3, but where the other distinct market participant is also a Child Software Application Downloading Party 7. However, those versed in the art will envision other use case combinations where Financial Instrument Market Participants 31 will mix and match tools to communicate in an efficient and suitable manner.

As such, no actual execution, settlement, or clearing need be consummated through the preferred embodiment of the Disclosure. Instead, the Disclosure in its most simple embodiment merely enables the unlimited sharing of financial instrument characteristics (growing the number and diversity of financial instruments as well as growing the number of parties willing to create a market in such financial instruments) and where there is interest in acquiring such a financial instrument puts the relevant parties in contact with each other for purposes of arranging an “outside the system” sale of the financial instrument represented by the Child Software Application 5.

If needed, however, the current Disclosure can also incorporate a execution function where the sale of a financial instrument represented by a Child Software Application 5 is consummated (actual consideration passes between the Financial Instrument Market Participants 31), with such consummation being done by the Disclosure itself or handed off to a third party (e.g., a clearing or settlement agency) by the System Administrator 1. In this regard, the system could handle all (end to end) or only parts of the execution processes, including but not limited to functions relating to making offers, counter offers, acceptances of offers, full or partial payment between the parties (or their agents) for agreed offers, transfer of title relating to consummated transactions, and analogous.

Similarly, the system can serve as a regulatory reporting and market monitoring tool by having data within the system be aggregated (anonymously, partially anonymous, or not anonymous) and provided to regulatory bodies seeking to have monitoring, supervision, and/or management capabilities with regard to a set of financial instruments and associated market participant activity within the market.

As previously described, the Parent Software Generator 3 is created specifically by the System Administrator 1 for a Parent Software Generator User 4 (perhaps the owner of an existing economic contract or financial instrument generating a particular “benefit” or “expectation” for that owner, or in the alternative, a party that is willing to create such a contract or financial instrument and sell its economic expectation onward to another party as part of a new transaction) who wishes to use the Parent Software Generator 3 to create a unique Child Software Application 5 that virtualizes the characteristics of the contract or financial instrument in question (whether such contract or financial instrument is existing or merely contemplated) so that others may download and interact with such a Child Software Application 5 and may learn of its existence and ascertain whether they wish to purchase such contract or financial instrument (or request the creation of a similar contract or financial instrument) from the Parent Software Generator User 4 or another party associated with the Parent Software Generator User 4.

In some instances, the delivery of the Parent Software Generator 3 to the Parent Software Generator User 4 may be through a web-based front-end (an online portal, home page, hosting environment, or analogous) for consideration being paid for such service to the provider and/or creator of the Parent Software Generator 3 (e.g., the System Administrator 1) and possibly having further consideration being paid to the System Administrator 1 being tied to market activity generated by the Parent Software Generator's 3 existence (e.g., commissions based on the number of Child Software Applications 5 downloaded by system users, or the number and/or type of messages generated by system users pertaining to a particular Child Software Application 5).

For the avoidance of doubt, the Parent Software Generator 3 is capable of creating any number of stand alone applications (Java, Android, webOS, MeeGo, iPhone, Windows, etc.) or similar applications that need to be run within another software application envelope (such as the Parent Software Generator 3 or the Child Software Application Reader 8).

In terms of the information that may be incorporated into the Child Software Application 5 by the Parent Software Generator 3 pursuant to the instructions of the Parent Software Generator User 4, the Disclosure contemplates that any type of financial instrument or contract documentation and terms may be included, with or without information relating to counterparties and other affiliate information. Of note, the Child Software Application 5 may also have the ability to communicate dynamic market relevant information that may be modified automatically or manually, and make use of one or more pre-determined formula for determining size and tenure of contract benefit, as well as counterparty risk measurements.

The Disclosure also contemplates using application programming interfaces (“APIs”) to enable direct importation of requisite data feeds (e.g., Bloomberg feeds), as well as manual input fields to enable a user of the Child Software Application 5 to override requisite data feeds or static formula assumptions where the user does not have access to, or does not wish to use such requisite data feeds.

The Disclosure also envisions the use of an encrypted two-way communication mechanism to allow a user of the Child Software Application 5 to communicate directly with another system user of counterparty for purposes of receiving additional information, to request a quote to purchase such contract or financial instrument (or a similar one), to offer a bid to purchase such contract or financial instrument (or a similar one), and/or suggest a method of executing on a potential transaction relating to such contract or financial instrument (or a similar one), whether via a face-to-face exchange or through a third-party intermediary to shield one or more of the identifies of the negotiating parties, or some analogous mutually acceptable method.

Further, the Disclosure has the ability to easily upload a Child Software Application 5 to the System Administrator's 1 Online Storage Facility 6 by the Parent Software Generator User 4 using the Parent Software Generator 3 and thereafter downloaded by an Application Seeking Registrant or Child Software Application Downloading Party 7 who has registered with the system.

The Disclosure also makes use of descriptive keyword notations made by the Parent Software Generator User 4 during the Child Software Application 5 creation process that can be used to populate a system registry with key words linked to such a Child Software Application 5 that are searchable by a system user wishing to find, review, and/or download a particular type of Child Software Application 5 dealing with a particular financial instrument. Further, such search mechanism can allow the searching party the ability to partially review the Child Software Application 5 within the Online Storage Facility 6 prior to download of the Child Software Application 5.

In addition, the System Administrator 1 can maintain the Disclosure (creation and delivery of the Parent Software Generator 3, creation and storage of all identification codes tied to system software elements and the users of such system software elements, the storage of Child Software Applications 5, the shepherding of anonymous (or non-anonymous) messages between Parent Software Generator Users 4 and Child Software Application Downloading Parties 7 for free, on a subscription basis, and/or a performance basis as the case may be (facilitation of price and party discovery).

In one embodiment, one or more of the Child Software Applications 5 and the Parent Software Generator 3 will have an “offer” function (e.g., a virtual button) that will be used when a final offer (quantum, price, and special terms set forth in accompanying document attachments or message text) is forwarded from a Child Software Application Downloading Party 7 to a Parent Software Generator User 4 (all Financial Instrument Market Participants 31) or vice versa. Where a Financial Instrument Market Participant 31 submits an offer via the “offer” function, the Message Server 13 will recognize such and deliver the offer to the other Financial Instrument Market Participant 31 (e.g., the Child Software Application Downloading Party 7 or the Parent Software Generator User 4) along with a secure link to an application associated web-based confirmation registry where the relevant Financial Instrument Market Participant 31 will select from a “refuse” or “acceptance” function that will deliver a confirmed refusal or acceptance to the offering Financial Instrument Market Participant 31 (e.g., the Parent Software Generator User 4 or the Software Application Downloading Party 7). Where an offer is accepted, the Disclosure's System Administrator 1 will prepare and deliver to one, some or all of the Child Software Application Downloading Party 7, Parent Software Generator User 4 or their agents an invoice for the amount of commission pre-agreed with the Disclosure's System Administrator 1 at the time the Parent Software Generator 3 was created and delivered to the Parent Software Generator User 4. Further, this function can be managed by the Disclosure's System Administrator 1 itself or can be outsourced to an entity (unregulated or regulated) specializing in executing such transactions.

In another embodiment, where the transaction as facilitated by the Disclosure fails to be consummated (inside or outside the system by the parties and/or agents to the parties), the commission could be refunded to the Parent Software Generator User 4 (or other parties so entitled to such a refund) if notice is given to the Disclosure's System Administrator 1 within a set period of time and upon adequate proof of the failure to consummate the transaction.

In the alternative, the Disclosure contemplates the addition of an execution component whereby the Disclosure's System Administrator 1 also engages in the actual sale consummation of the contract or financial instrument from one party to another. While this increases the functional requirements of the Disclosure (and operational costs and risks for the Disclosure's System Administrator 1), it also ensures that the commission to the Disclosure's System Administrator 1 for a consummated transaction is paid at the time of such transaction.

In addition to the improving the markets for financial instruments (including but not limited to complex financial instruments, non-standard financial instruments, derivative instruments such as swaps, futures, and options, and analogous), the current Disclosure can also serve as the facilitation mechanism for other alternative and/or non-alternative financial instruments like equities, bonds, loans, energy credits (e.g., renewable energy credits), pollution credits (e.g., carbon credits), weather contracts, tax credits, and other asset and liability representations of value that would be better served by the current Disclosure as opposed to being traded over a centralized exchange, clearinghouse, or through non-application enabled peer-to-peer market making (e.g., traditional brokerage operations that use a host of techniques distinct from the current Disclosure to facilitate transactions in that particular instrument).

Similarly, while the present disclosure has numerous embodiments that facilitate peer-to-peer financial instrument contract creation and/or title transfer, the disclosure also is capable of facilitating (i) non-financial instrument contract creation and title transfer and (ii) quasi-financial instrument contract creation and title transfer, such as peer-to-peer agreements relating to electronic gaming and event wagering, whether such agreed upon event outcomes (including consequent liabilities and entitlements accruing to participating parties who have taken asset positions relative to particular event outcomes) deal with card games, board games, fixed-odds betting, parimutuel betting, prediction markets, spread betting, sport betting, horse race betting, dog (e.g., greyhound) race betting, political outcome betting, arbitrage betting, event betting, weather betting, commodity betting, financial market betting, back bets, lay bets, or analogous types of wagering.

The use of “one application per one financial instrument” technique also bolsters the ability of the System Administrator 1 to offer a low cost, secure, and efficient anonymous financial instrument discovery and price negotiation prior to execution, and then peer-to-peer trades (over the counter type) executions thereafter (e.g., outside of the system through an independent settlement function, or within the system) but with greater transparency than the status quo. It is also possible that the current Disclosure will promote the creation of even more transparent data for certain difficult to value markets when compared to an existing centralized framework since more people might participate in the Disclosure's system due to the availability of free data streams, low cost participation, and ease of use.

The current Disclosure also benefits from certain “social networking” aspects in that it enables participants to not only signal to other Financial Instrument Market Participants 31 their own credibility within the financial instrument markets, but it allows Financial Instrument Market Participants 31 to ascertain the quality of counterparties that they may choose to engage with prior to actually communicating with them directly. Specifically, the current Disclosure contemplates several unique vetting functions that can be used in a plurality of scenarios to better serve all Financial Instrument Market Participants 31 as they assess the pros and cons of engaging with a particular market participant, whether they be an actual or prospective counterparty, agent, advisor, or other entity, and to engage in this vetting process while one or both of the communicating parties remains anonymous.

Of note, the Disclosure has several unique features that encourage Parent Software Generator Users 4, requesting parties, and Application Seeking Application Seeking Registrants 7 to create, share, review, and communicate data relating to their prospective or existing financial instruments virtualized within their Child Software Applications 5, and likewise encourage one, some or all of the Child Software Application Downloading Party 7, Parent Software Generator User 4, and the Application Seeking Registrant to share certain system usage information about themselves with other system users prior to or during the course of their online interactions via the Disclosure. By encouraging these behaviors, the current Disclosure will become more valuable to users as the number of Child Software Applications 5 created, uploaded, downloaded, and reviewed increases, and similarly, the system will be more effective for providing transparency and discovery with greater communication engagements between Financial Instrument Market Participants 31 (the number of anonymous and non-anonymous messages being sent from and to respective system users via the Disclosure).

To encourage the system users to generate more content (Child Software Application 5 creation) and interact more frequently and in a more qualitative manner around such content (improved messaging, analysis, sharing of data) the Disclosure can also enable system users to generate certain usage statistics and ranking tables describing their own system use behaviors and share that with others (sharing this data internally within the system via user or system generated and published or downloaded reports or externally through other social networking platforms such as Facebook, Google+, LinkedIn, or otherwise). In this way, each Child Software Application 5 can be provisioned with customized usage behavior statistics pertaining to the system activities of that particular creator of that particular Child Software Application 5 (the Parent Software Application User 4). For some Child Software Application 5 created, this creator may wish to share many aspects of their system usage behaviors; in another Child Software Application 5 so created, perhaps less details may be shared. The Child Software Application 5 reviewer (the Child Software Application Downloading Party 7 and Application Seeking Registrant) can then look at these rankings and decide whether this is a party they wish to communicate with initially or on an ongoing basis. Similarly, the reviewers of the Child Software Application 5 may wish to share similar information about their own system use statistics with the creator of the Child Software Application 5 (the Parent Software Application User 4) they wish to communicate with (again, varying the amount of use data they share with such Parent Software Generator User 4 based upon the circumstances surrounding the Child Software Application 5 being reviewed and generating the appropriate anonymous or non-anonymous communication.

As a practical matter, this system usage data is created by the System Administrator 1 by aggregating information provided within each Child Software Application 5 and Parent Software Generator 3 (from the same data set that was used to create the Child Software Application 5) along with the upload, download, and messaging trails resulting from the Child Software Application 5 creation, upload, download, and review process managed by the system.

In terms of how the this information is customized by the Child Software Application 5 creator (the Parent Software Application User 4) and the Child Software Application 5 reviewer (the Child Software Application Downloading Party 7) in the course of using the system, both the Parent Software Generator 3 and resulting Child Software Application 5 will have buttons, tick boxes, and other input functions embedded therein which can allow each user to customize their statistical profile as shared with the other party. Clearly, the more data that is shown by one party to the other, the greater the likelihood that such party will feel comfortable interacting with that other party. Similarly, the more active a particular party is (as denoted by the usage statistics shared and perhaps their ranking in that regard compared to other system users), the greater the likelihood that other parties will choose to interact with them as opposed to another party offering a similar application (e.g., the more active you are within the system in terms of Child Software Applications 5 created, uploaded, downloaded, messages sent, and messages received, the greater the likelihood of attracting new interactions from other system users). Along with the “application-centric” design of the Disclosure, this unique system usage ranking capability will be a key differentiator for the Disclosure and increase its utility.

In this regard, the following is an outline of some of the system usage features that can be incorporated into the Disclosure's Parent Software Generator 3 and/or resulting Child Software Application 5, beginning with a feature set to be incorporated within the Parent Software Generator 3 comprised of an interactive input page (e.g., also tied to a messaging function) featuring any one or more of ranking profile data interactive tick boxes (or analogous) where the Parent Software Generator User 4 can select their own system use and market characteristic rankings data to be shared with the Child Software Application 5 downloading community when they find this particular Child Software Application 5. Of note, the statistical information that can be collected and shared includes (but is not limited to): (i) the number of Child Software Applications 5 uploaded by that particular Parent Software Generator User 4; (ii) the number of Child Software Applications 5 downloaded by that particular Parent Software Generator User 4; (iii) the number of messages received by that particular Parent Software Generator User 4 related to their created Child Software Applications 5; (iv) the number of messages sent back by the that particular Parent Software Generator User 4 relating to their created Child Software Applications 5; (v) the notional value of the Child Software Applications 5 created by that particular Parent Software Generator User 4; (vi) the geographic spread of that particular Parent Software Generator User's 4 Child Software Applications 5 created (where their financial instruments are originated); and (vii) the statistical breakdowns of the types of underlying instruments that particular Parent Software Generator User 4 created in the course of creating such Child Software Applications 5 (equity/debt/interest rate/currency/commodity/other analogous characteristics).

Similarly, within the downloaded and opened Child Software Application 5 (whether opened by itself as a stand alone application or with the support of a Child Software Application Reader 8 or with the support of a Parent Software Generator 3) the Disclosure also contemplates the inclusion of an interactive input page (e.g., also tied to a messaging function) featuring any one or more of ranking profile data interactive tick boxes (or analogous) allowing the messaging party (the Child Software Application Downloading Party 7) to share their own system use characteristics and rankings with the Parent Software Generator User 4 that created that particular Child Software Application 5 thereby encouraging that particular Parent Software Generator User 4 to respond to any messages sent by the Child Software Application Downloading Party 7 from that particular Child Software Application 5, including: (i) the number of Child Software Applications 5 downloaded by that particular Child Software Application Downloading Party 7; (ii) number of messages sent by that particular Child Software Application Downloading Party 7 to various Parent Software Generator Users 4; (iii) the number of messages received by hat particular Child Software Application Downloading Party 7 from contacted Parent Software Generator Users 4; (iv) the notional and average value of the Child Software Applications 5 that particular Child Software Application Downloading Party 7 has downloaded via the system; (v) the geographic spread of Child Software Applications 5 downloaded by that particular Child Software Application Downloading Party 7 (e.g., where those financial instruments were originated), and; (vi) the statistical breakdowns of the types of underlying instruments that particular Child Software Application Downloading Party 7 downloaded via the system (equity/debt/interest rate/currency/commodity/other analogous characteristics).

Similarly, the following represents additional unique features that can be incorporated into the Disclosure's Parent Software Generator 3 and resulting Child Software Application 5. Of note, the Disclosure contemplates that within the Parent Software Generator 3 there be included of an interactive input page comprised of: (a) an interactive tick box (or analogous) stating whether the Child Software Application 5 being created by the Parent Software Generator 3 represents an actual financial instrument on the books of the Parent Software Generator User 4 or is a sample of a financial instrument they are capable of creating (this is an important point for purposes of searching and possible regulatory reporting down the road in various jurisdictions); (b) a set of interactive tick boxes (or analogous) (for Company X, Company Y, Company Z) where the Parent Software Generator User 4 can be e-mailed/informed of information about a trial or low cost subscription to a data feed service relating to the creation of the Child Software Application 5; (c) a set of interactive tick boxes (or analogous) (for Company A, Company B, Company C) where the Parent Software Generator User 4 can be e-mailed/informed of information about a trial or low cost settling or clearing function relating to the creation of the Child Software Application 5; and (d) a set of interactive tick boxes (or analogous) (for Company 1, Company 2, Company 3) where the Parent Software Generator User 4 can select how they want their Child Software Application 5 to be reported to a regulatory body or agency if need be.

Similarly, within the “opened” Child Software Application 5 the inclusion of an interactive input page (likely tied to a messaging function) comprised of: (a) a set of interactive tick boxes (or analogous) (for Company X, Company Y, Company Z) where the Child Software Application 5 reviewer can be e-mailed/informed of information about a trial or low cost subscription to a data feed service relating to the Child Software Application 5 being reviewed; (b) a set of interactive tick boxes (or analogous) (for Company A, Company B, Company C) where the Child Software Application 5 reviewer can be e-mailed/informed of information about a trial or low cost settling or clearing function relating to the Child Software Application 5 being reviewed; and (c) a set of interactive tick boxes (or analogous) (for Company 1, Company 2, Company 3) where the Child Software Application 5 reviewer can select how they want their resulting Child Software Application 5 (for a new deal) to be reported to a regulatory body or agency if need be.

Taken as a whole, this type of data collection can not only assist system users in determining the quality and characteristics of other system users and their authored content prior to engaging with them, but can also assist the System Administrator 1 as it rolls out different versions of the Disclosure in different markets, collect different data sets for analysis or to satisfy regulatory requirements, or to offer new commercial terms to its own customers (e.g., upload fees for Child Software Applications 5 varying upon the actual number of Child Software Applications 5 created by that particular Parent Software Generator User 4 and uploaded within a set period of time, messaging fees for Child Software Application Downloading Party 7 varying upon the actual number of Child Software Application 5 messages sent by that Child Software Application Downloading Party 7 within a set period of time, messaging fees for Parent Software Generator Users 4 varying upon the actual number of reply messages sent by that Parent Software Generator User 4 within a set period of time, the waiving of Child Software Application 5 upload fees for a set period of time to encourage new users to populate the system with Child Software Applications 5, and other commercial system use structures whether based upon one or more of the number of messages sent, Child Software Applications 5 uploaded, Child Software Applications 5 downloaded, the length of time such Child Software Applications 5 are in the system's Online Storage Facility 6, the notional deal size of the financial instrument represented by the Child Software Applications 5, the various commercial characteristics of the financial instrument represented by the Child Software Applications 5, or otherwise and that those versed in the art can contemplate).

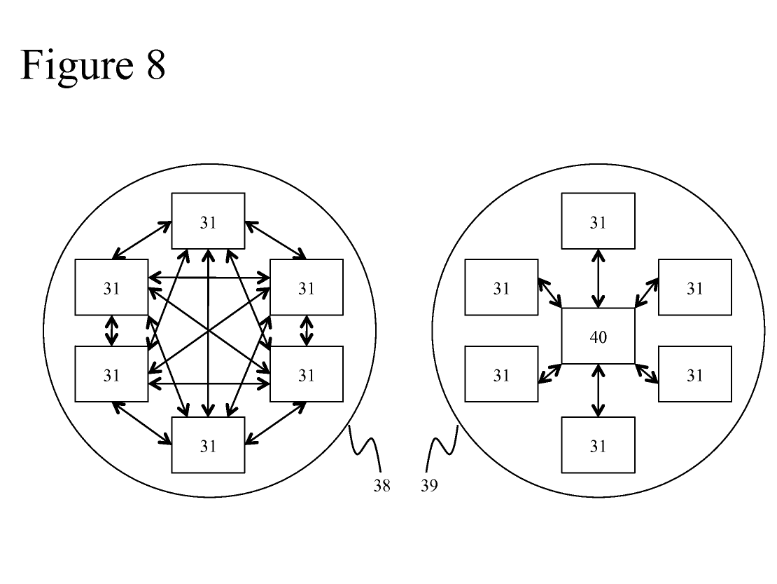

In light of the aforementioned description, it should be clear to those in the field that the current Disclosure is unique and differentiated from the prior art concerning platforms for finding, accessing, and transacting in financial instruments. Further to this point and by way of background, FIG. 8 shows two common financial instrument trading mechanisms currently used by the markets. The first, represented by grouping 38 represents the transactional relationships observed in a traditional peer-to-peer “over the counter” market. In such a market, each counterparty (usually a financial institution or large company) has bilateral trading agreements with each of the others based upon personal relationships. In this system, each counterparty knows only its trades (contracts or financial instruments) with the other party and not that party's trades with the other counterparties or other trades generally within the system. Further, while some of the execution and back-office functions relating to these over the counter transactions are electronically automated, the front-end discovery and origination process (finding the financial instrument, finding the counterparty, assessing the instrument and the counterparty prior to communicating with them, negotiating terms, etc.) is not electronically automated and instead relies on the existence of traditional social networks between market participants utilizing a variety of non-unified communication techniques (e.g., ad hoc use of phone, fax, e-mail).

Historically, this model can handle both standard and complex/customized transactions in financial instruments, but is limited in its ability to quickly generate valuable market relevant information, such as an indication of a “bid” or an “ask” without the intervention of a broker, and is severely limited in its ability to create new networks of parties that may wish to engage with each other on a peer-to-peer basis. In short, the strengths of the current over the counter market are that there is trading flexibility for trading non- standard financial instruments, relatively low maintenance costs for owners of financial instruments, and flexible mark to market for financial instrument owners (“mark to model”). However, this over the counter market has significant weakness due to its inability to quickly produce efficient pricing data and volume transparency, suffers from poor liquidity, is limited to bilateral netting between counterparties, does not have an efficient means of integrating relevant data feeds into the analytical portions of the financial instruments, and usually requires the services of an intermediary broker or dealer that charges a significant fee or commission to set-up and execute a transaction relating to the financial instrument.

Turning to the second block diagram on FIG. 8 representing a centralized trading and clearing system 39, one can also see severe limitations that the current Disclosure addresses and is unique in comparison. Of note, with a central platform, each counterparty trades with or through a central party who often assumes the financial risk associated with doing a transaction between the two counterparties. And for some financial instruments (standardized instruments such as well known listed equities) this type of hosting environment provides good transparency on prices and volumes. In this sense, this model (clearinghouses and exchanges) are best structured for handling standardized trades. However they are not effective at handling non-standard financial instruments or complex/customized contracts as they are too costly to list (the traditional central platform will charge a considerable amount to list, price, and/or settle the trade), and trading volumes will be too low to justify this cost from the prospective of the party creating the financial instrument. So, in the case of a central model dealing with well-known and standardized financial instruments, there are strengths relating to pricing and volume transparency and liquidity, solid mark to market valuation mechanisms, the ability for counterparties to net out their positions vis-à-vis one another, the ability of such exchanges to be electronically automated, and their ability to manage counterparty risk (trade execution guarantees by the operator of the centralized exchange or facility). However this system has weakness when it tries to manage non-standardized financial instruments since putting many types of non-standardized financial instruments into such a centrally managed system has integration and maintenance costs that are too high for financial instrument owners, they are difficult and expensive to build since they require a level of quality of service and speed that is difficult to assure for all participants, they are not well-suited to handle complexity in terms of the financial instrument types brought into the system, sharing of key documentation is very difficult to achieve, only the largest entities can afford to participate in such systems (making markets less efficient for all parties), and the exchanges and clearing systems must be heavily regulated and are therefore expensive to build and maintain in a manner that satisfies regulatory needs.

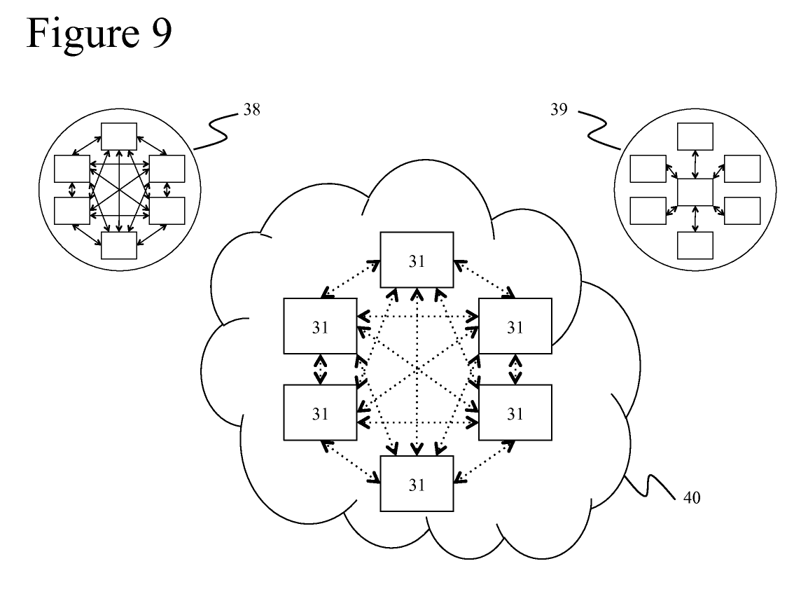

Against this background the current Disclosure is unique in that it is able to apply electronic automation capabilities to key functions within an over the counter, peer-to-peer market (e.g., via the quick and low-cost authoring of searchable and downloadable Child Software Applications 5 by Financial Instrument Market Participant 31 who can communicate securely and discreetly amongst each other) without incurring the cost of building a very expensive centrally traded or cleared marketplace. Turning to FIG. 9 one can see this in the block diagram group 40 where counterparties can engage with each other on a peer-to-peer basis—much like the existing over the counter market seen in group 38, but do so utilizing novel social networking and peer-to-peer communications. In this sense, the current Disclosure combines the peer-to-peer capabilities of group 38 and the electronic automation capabilities of group 39, and ties the two together through a unique system of application toolkits (the Parent Software Generator 3), user-generated and user-published virtual financial instruments (the Child Software Application 5), the secure Message Server 13, the search term data base for finding relevant applications, the User Identification Code Databases 22, the User Addressing Databases 23, and the other technical innovations described herein.

Additionally, a novel aspect of the disclosure is the representation of a financial instrument by an autonomous software application wherein one embodiment the market participant is assigned a unique identification code associated with an assumed name chosen by the participant upon registering with the System Administrator 1, and wherein said system assigns different unique identification codes to the same market participant for multiple registrations relating to the creation of multiple Child Software Applications 5.

Another novel aspect of the Disclosure is the integration of all workflow into a centralized and integrated program (e.g., a DerivaLink or analogous) wherein participants can search and download the Child Software Applications 5 from a web browser, and execute the Child Software Applications 5 to view its attachments and send outbound messages. In this regard, the DerivaLink element provides a centralized cockpit from which participants can register for different unique identification codes, create and upload Child Software Applications 5, send outbound messages and receive inbound messages, and search, download, and execute published Child Software Applications 5 from the Online Storage Facility 6.

Another novel aspect of the disclosure is the anonymity and security in the communication among participants. Information—including but not limited to electronic mail addresses, phone numbers, and mailing addresses—supplied by participants at the time of registration with the system can be qualified as “public”, “private”, or “by request” by the respective participants. “Public” information is available to all Participants. “Private” information is available to only the System Administrator 1, and access to “by request” information can be granted on a case by case basis by one participant to another. When inbound and outbound messages are exchanged, only the assumed names are known to participants. Message contents are encrypted using the public key that is created for or derived from the sending or receiving participant unique identification codes. It is important that even the originating IP addresses of one participant' computer cannot be traced by another participant. Therefore, all messages among participants are relayed through the Message Server 13. It is further novel that even though the Message Server 13 relays the messages, it itself does not have the necessary security credential to view the said messages' contents. As such, the credentials are solely the properties of the sending and receiving participants' utilizing their unique identification codes.

In summary, the advantages of the current Disclosure are that it provides: (a) a unique and novel application based ecosystem that is far easier to code for complexity (exotic financial instruments are easier to create and negotiate); (b) a unique and novel application based ecosystem that is far easier to share documentation being “dragged and dropped” into the application during its creation process (using the toolkit); (c) a unique and novel application based ecosystem that is far cheaper to maintain across an entire platform (low cost and high quality security, speed, privacy and auditing provided for); (d) a unique and novel application based ecosystem that is far better suited to serving an entity that needs to communicate its position to others and to do so in a manner that has cost savings compared to traditional “listings” (resulting in more financial instruments being generated as well); (e) a unique and novel application based ecosystem that is far more open and allows any entity to review its contents (subject to situational specific permission requirements placed by the application creator); (f) a unique and novel application based ecosystem that leads to far better transparency on the bid and ask, which is good for mark to market and liquidity purposes (bids come in directly to seller via the application—not routed through an exchange), yet still permits users to utilize a “mark to model” if desired; (g) a unique and novel application based ecosystem that is far more capable of preserving various levels of anonymity to potential financial instrument sellers and buyers than found with other discovery platforms, with continued anonymity if agents are used to execute transactions (avoiding face to face engagements between counterparties); (h) a unique and novel application based ecosystem that is far more likely to encounter more modest regulatory constraints (if any); (i) a unique and novel application based ecosystem that is far more flexible where financial instruments are held by more than one seller since each seller can market their own holdings through their own customized Child Software Application 5 (and therefore can also request specialized bids), which can generate greater opportunity for tiered pricing and competition as well; (j) a unique and novel application based ecosystem that enables a data provider to be able to earn fees or commission for each financial instrument sale as opposed to subscription amount if data feeds embedded for free within an application that generates a transaction; (k) a unique and novel application based ecosystem that allows each application creator to get exposure to thousands of more clients globally with little or no cost; (1) a unique and novel application based ecosystem that has no specific requirement for Excel plug-ins or other software (however, the system does not prohibit such integrations); (m) a unique and novel application based ecosystem that can be used to actually solicit new financial instrument proposals (ability of a counterparty to post an application for a new kind of financial instrument into the market for review by potential counterparties); and (n) a unique and novel application based ecosystem that is operational on all device types (web platform suitable for mobile or fixed devices).

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method for facilitating actions to be performed on a data set using processing environments and network interfaces of respective computers used by a system administrator, a user and a market participant, the method comprising:
using the system administrator's computer's processing environment, incorporating a first identification code into a software development kit (SDK) that is configured to virtualize the data set;
providing the user access to the SDK via the network interface of the system administrator's computer, thereby enabling the user to author a customizable software application incorporating a second identification code, such that the customizable software application includes a virtualized version of the data set, where the SDK is identifiable by the first identification code;
using the network interface of the system administrator's computer to maintain a communication link to an online storage facility where the customizable software application authored by the user is uploaded for being hosted and accessed; and
utilizing the first identification code and the second identification code for tracking action performed by the user and the market participant on the virtualized data set using the customizable software application authored by the user and hosted by the online storage facility.

2. The method of claim 1, wherein the online storage facility comprises servers in a cloud network coupled to the system administrator's computer, the user's computer and the market participant's computer.

3. The method of claim 1, wherein the virtualized data set comprises existing or prospective financial instrument selected from a group consisting of: a derivative, a financial contract, a financial transaction record, a promissory note, and a data set representing ownership indicia of an item, service or media content.

4. The method of claim 1, wherein the virtualized data set comprises a non-financial data set comprising one or more of: information about media content, social network data, information about a physical item.

5. The method of claim 1, wherein the user is a software developer.

6. The method of claim 1, wherein the market participant is one or more of the system administrator, the user, or a third party other than the system administrator and the user.

7. The method of claim 1, wherein the action performed on the virtualized data set comprises one or more of: searching for the virtualized data set; seeking permission to register for using the customizable software application having the virtualized data set; downloading the customizable software application having the virtualized data set; reviewing the virtualized data set; installing the customizable software application having the virtualized data set into a third party computer; performing financial transaction on the virtualized data set; and, communicating with peers regarding the virtualized data set.

8. The method of claim 1, wherein the customizable software application authored by the user utilizes a native language used by the SDK.

9. The method of claim 1, wherein the customizable software application authored by the user utilizes a second language other than the language used by the SDK, wherein the SDK includes appropriate software add-ons to enable interoperability of the SDK and the customizable software application.

10. The method of claim 1, wherein a third identification code is added to the customizable software application when a particular market participant attempts to download a particular customizable software application, such that the particular market participant's engagement on the particular customizable software application is trackable by the system administrator and the user who created the particular customizable software application by analyzing the relationship between the first identification code, the second identification code, and the third identification code.

11. The method of claim 1, wherein the a particular user and a particular market participant are engaged in communication that is encrypted.

12. The method of claim 1, wherein a user and a market participant engage in peer-to-peer communication in an anonymous manner.

13. The method of claim 1, wherein the user uploads the customizable software application in an anonymous manner.

14. The method of claim 1, wherein the market participant performs an action on the customizable software application in an anonymous manner.

15. The method of claim 12, wherein a granularity of privacy level in the peer-to-peer communication is adjustable.

16. The method of claim 15, wherein the granularity of privacy level comprises one or more of: private, semi-private and public.

17. The method of claim 15, wherein a pricing associated with message delivery in the peer-to-peer communication is decided by the system administration based on the granularity of privacy level.

18. The method of claim 1, wherein the customizable software application is self-executing in determining whether a market participant attempting to perform an action on the customizable software application has the desired level of access required to be able to perform that action.

19. A non-transitory computer-readable storage medium having computer-executable instructions stored therein for causing computers to perform a method for facilitating actions to be performed on a data set using processing environments and network interfaces of respective computers used by a system administrator, a user and a market participant, the method comprising:
using the system administrator's computer's processing environment, incorporating a first identification code into a software development kit (SDK) that is configured to virtualize the data set;
providing the user access to the SDK via the network interface of the system administrator's computer, thereby enabling the user to author a customizable software application incorporating a second identification code, such that the customizable software application includes a virtualized version of the data set, where the SDK is identifiable by the first identification code;
using the network interface of the system administrator's computer to maintain a communication link to an online storage facility where the customizable software application authored by the user is uploaded for being hosted and accessed; and
utilizing the first identification code and the second identification code for tracking action performed by the user and the market participant on the virtualized data set using the customizable software application authored by the user and hosted by the online storage facility.

20. The non-transitory computer-readable storage medium of claim 19, wherein the virtualized data set comprises data set pertaining to a financial instrument.
